(19) United States
(12) Patent Application Publication
(10) Pub. No.: US 2020/0312142 A1
(43) Pub. Date: Oct. 1, 2020

(54) System and a Method for Improving Road Safety and/or Management

(71) Applicant: Hong Kong Applied Science and Technology Research Institute Co., Ltd., Shatin (HK)

(72) Inventors: Dongzhe Su, Ma On Shan (HK); Hang Chen, Kowloon Bay (HK); Hua Xia, Ma On Shan (HK); Siu Ping Chan, Kornhill (HK); Ka Ho Mui, Kowloon (HK)

(21) Appl. No.: 16/364,399

(22) Filed: Mar. 26, 2019

(51) Int. Cl. G08G 1/0967; G08G 1/01; G05D 1/02; H04W 4/44

(52) U.S. Cl. CPC G08G 1/096783; G08G 1/096725; G05D 2201/0213; G05D 1/0285; H04W 4/44; G08G 1/0116

(57) ABSTRACT

Provided is a system for improving road safety of a vehicle. The system comprises a central management platform for managing a plurality of network cooperation engine (NCE) modules. Each NCE module manages a plurality of edge gateway devices (EGWs) which are each located in a respective defined geographical area of limited size. Each EGW communicates with multiple roadside units (RSUs) in its area and exchanges real-time and low latency information with said RSUs and with any vehicle on-board data processing units (ICGWs) in vehicles presently within its area. Each ICGW is adapted to be installable in a vehicle. The ICGW is configured to receive real-time data from one or more on-board vehicle modules. The ICGW is also configured to receive data from its EGW and the RSUs which are themselves configured to receive data from a plurality of sources located within said defined geographical area and to transmit said received data and/or data derived from said received data to said ICGW. The ICGW is configured to process data to autonomously determine any one or more of: a threat to the vehicle; an alert to be issued; and a control action to be implemented for the vehicle. A size of the defined geographical area may be selected such as to enable data from said EGW and/or RSUs to be transmitted to said ICGW in real-time or at least at or less than a first, low level of latency.

### FIELD OF THE INVENTION

The invention relates to a system and a method for improving road safety and/or management and, more particularly, but not exclusively, to a Vehicle-to-Everything (V2X) software system for improving road safety and/or management.

### BACKGROUND OF THE INVENTION

Vehicle-to-Everything (V2X) is a vehicular communication system configured to deliver information from a vehicle to any entity that may affect the vehicle, and vice versa. The system incorporates other more specific types of communications including, but not limited to, Vehicle-to-Infrastructure (V2I), Vehicle-to-Vehicle (V2V), Vehicle-to-Pedestrian (V2P), Vehicle-to-Device (V2D), and Vehicle-to-Grid (V2G).

Conventionally, vehicle on-board data processing units have typically been configured to use only real-time data retrieved from on-board vehicle modules to determine or detect threats and/or to generate safety alarms for vehicle users and/or other near-by road users. Consequently, in known systems, the threat detections and/or alarm determinations are based on only in-vehicle localized information. Such systems do not normally utilize a vehicular communication system such as V2X to manage communications for information and/or data exchange between vehicle on-board data processing units and, for example, roadside infrastructure for road safety and/or threat determination purposes.

Disclosed in U.S. Pat. No. 10,172,009 B1 is a V2I communications system in which broadcast data towards vehicles must use the network resources efficiently whilst unicast data must arrive reliably with ultra-low-latency. A vehicle with a special communications module and an internal computer can connect to one or more 5G vehicular network slices (VNS) with multiple Radio Access Technologies (multi-RAT) in order to efficiently communicate with local or remote transportation information databases and applications, road safety and emergency infrastructures. The infrastructures use the network-slicing feature of a 5G mobile network to carve out vehicular data and control planes specialized to offer the vehicular service only. The vehicular network slice further comprises: (i) a Road Side Access Unit (RSAU), (ii) a Vehicle Id Registrar (VIR), (iii) a Vehicular Slice Manager (VSM), and (iv) distributed Virtual Transportation Network Functions (VTNF).

WO 2018/145067 A1 discloses a user equipment (UE) or network device such as a vehicle UE (V-UE) or pedestrian UE (P-UE) which can configure resources independently for communication with other V-UEs/P-UEs to avoid collision and ensure safety. The UEs can operate to independently monitor and configure their own resources via partial sensing window configurations that can dynamically be configured to perform resource (re)selection in response to a resource reselection trigger. An exclusion of detected resources that are reduced or occupied by other devices can be performed, and a resource candidate set generated to select resource candidates for long term evolution (LTE) vehicular communications. UE partial sensing mechanisms and congestion control can be enhanced for these communications via efficient power control and signaling reliance for vehicle communication quality, as well as pedestrian safety.

Hindawi, Mobile Information Systems, Vol. 2017, published article ID 8923782, entitled “LTE Network Enhancement for Vehicular Safety Communication” by Wooseong Kim and Eun-Kyu Lee discloses that direct vehicle-to-vehicle (V2V) and vehicle-to-infrastructure (V2I) communication systems have been considered for safe driving of manned or unmanned vehicles. V2I communication is considered better than V2V communication for propagating safety messages at critical points like intersections where the safety messages must be delivered to surrounding vehicles with low latency and loss, since transmitters as infrastructure can have a line of sight to the receiver vehicles and control wireless medium access in a centralized manner unlike V2V. This publication proposes an enhancement of a current LTE system specified by 3rd-Generation Partnership Project (3GPP) LTE standards while addressing some delay challenges to satisfy requirements of safety message delivery.

Despite the foregoing disclosures, there remains a need for enhancing safety alarm generation and/or threat detection for vehicular road safety and/or management purposes by using multiple sources of information such as vehicles, roadside infrastructure, communications network, etc. with low latency communication of information.

### OBJECTS OF THE INVENTION

An object of the invention is to mitigate or obviate to some degree one or more problems associated with known systems and methods of improving vehicular road safety and/or management of vehicles.

The above object is met by the combination of features of the main claims; the sub-claims disclose further advantageous embodiments of the invention.

Another object of the invention is to provide a vehicular communication system based on a defined local geographical area managed by and/or in data communication with an edge gateway module configured to process real-time and/or low latency locally retrieved data to thereby provide such local data in real-time and/or with low latency to vehicles within said defined local geographical area.

Another object of the invention is to provide a system and method for improving road safety and/or management of a vehicle.

Another object of the invention is to provide an end to end V2X network system and method for improving road safety and/or management of vehicles.

Another object of the invention is to provide a multi-tiered system and method for improving road safety and/or management of a vehicle where a local level tier of the multi-tiered system operates at the lowest latency level compared to other higher-level tiers.

One skilled in the art will derive from the following description other objects of the invention. Therefore, the foregoing statements of object are not exhaustive and serve merely to illustrate some of the many objects of the present invention.

### SUMMARY OF THE INVENTION

For enhancing safety alarm generation and/or threat detection accuracy for vehicles, for example, multiple sources of information such as vehicles, pedestrian devices, roadside infrastructure, and communications network(s), etc. are required at low latency signal processing and delivery levels. In one embodiment, the present invention provides an end-to-end V2X network system having a multi-tier system architecture which utilizes information and algorithms performed at different tiers of the V2X network system to enable low latency generation of vehicle/road safety alarms and/or low latency determination of vehicle/road threats.

The invention therefore generally relates to a Vehicle-to-Everything (V2X) software system for improving road safety and/or management and, more particularly, but not exclusively, to a multi-tier V2X software system to enable low latency road safety V2X alarm detection/threat determination at a local level whilst using information and algorithms performed at different higher level tiers of the system operating at different, higher latency levels.

In a first main aspect, the invention provides a system for improving road safety and/or management of a vehicle. The system comprises a vehicle on-board data processing unit for a vehicle. The vehicle on-board data processing unit is configured to receive real-time data from one or more on-board vehicle modules. The vehicle on-board data processing unit is also configured to receive data from one or more roadside units located within a defined geographical area and which are themselves configured to receive data from a plurality of sources located within said defined geographical area and to transmit said received data and/or data derived from said received data to said vehicle on-board data processing unit. The vehicle on-board data processing unit is configured to process said real-time data from said one or more on-board vehicle modules and said data from said one or more roadside units to autonomously determine any one or more of: a threat to the vehicle; an alert to be issued; and a control action to be implemented for the vehicle. A size of the defined geographical area may be selected such as to enable data from said one or more roadside units to be transmitted to said vehicle on-board data processing unit in real-time or at least at or less than a first, low level of latency.

In a second main aspect, the invention provides a method of improving road safety of a vehicle comprising receiving real-time data from one or more on-board vehicle modules and receiving low latency data from one or more roadside units placed within a defined geographical area. The one or more roadside units are arranged to receive data from a plurality of sources located within said defined geographical area. Said real-time data from said one or more on-board vehicle modules and said data from said one or more roadside units are processed to autonomously determine any one or more of: a threat to the vehicle; an alert to be issued; and a control action to be implemented for the vehicle. Said real-time data and said low latency data are preferably received and processed at a location within the defined geographical area and any determination made based on said data is delivered to a location within the defined geographical area. A size of the defined geographical area may be selected such as to enable data from said one or more roadside units to be transmitted to said vehicle on-board data processing unit in real-time or at least at or less than a first, low level of latency.

In a third main aspect, the invention provides a vehicle on-board data processing unit for improving road safety of a vehicle. The vehicle on-board data processing unit comprises a non-transitory computer-readable medium arranged to store machine-executable instructions and a processor connected to the non-transitory computer-readable medium configured to execute the machine-executable instructions and cause the vehicle on-board data processing unit to implement the method steps of the invention. The vehicle on-board data processing unit is configured to receive real-time data from one or more on-board vehicle modules and to receive low latency data from one or more roadside units placed within a defined geographical area where said one or more roadside units are arranged to receive data from a plurality of sources located within said defined geographical area. Preferably said data received by the one or more roadside units from said plurality of sources is real-time data or at least low latency data, i.e. data which is received by said roadside units within milli-seconds of being generated by any of said plurality of sources. Preferably, also, the vehicle on-board data processing unit is configured to receive data directly or indirectly from any one or more of said plurality of sources and/or to receive data directly or indirectly from any one or more of other sources such as other vehicle on-board data processing units associated with respective other vehicles and/or pedestrian communication devices. The vehicle on-board data processing unit is preferably configured to process any or all received data including said real-time data from said one or more on-board vehicle modules and said low latency data from said one or more roadside units to autonomously determine any one or more of: a threat to the vehicle; an alert to be issued; and a control action to be implemented for the vehicle.

In a fourth main aspect, the invention provides an edge gateway module for a system for improving road safety and/or management, said edge gateway module comprising a non-transitory computer-readable medium arranged to store machine-executable instructions and a processor connected to the non-transitory computer-readable medium configured to execute the machine-executable instructions. The processor causes said edge gateway module to receive data from one or more roadside units placed within a defined geographical area managed by and/or in data communication with said edge gateway module and to transmit data received from said one or more roadside units and/or data derived from said received data to one or more vehicle on-board data processing units of vehicles located within said defined geographical area. A size of the defined geographical area is selected such as to enable data received from said one or more roadside units to be transmitted by said edge gateway module to said one or more vehicle on-board data processing units in real-time or at a first level of latency.

The summary of the invention does not necessarily disclose all the features essential for defining the invention; the invention may reside in a sub-combination of the disclosed features.

### BRIEF DESCRIPTION OF THE DRAWINGS

The foregoing and further features of the present invention will be apparent from the following description of preferred embodiments which are provided by way of example only in connection with the accompanying figures, of which:

FIG. 1 is a schematic diagram illustrating one embodiment of a system in accordance with the invention;

FIG. 2 is a schematic diagram of the system of FIG. 1 showing said system comprising an end to end V2X network;

FIG. 3 is a schematic diagram of the system of FIG. 1 showing more clearly the tiered structure of said system;

FIG. 4 is a block diagram showing the structure of an edge gateway module for the system of FIG. 1 and illustrating its connections to other entities and some of its information/data inputs;

FIG. 5 is a block diagram showing the structure of a network cooperation engine (NCE) module for the system of FIG. 1 and illustrating its connections to other entities and some of its information/data inputs;

FIG. 6 is a block diagram showing the structure of a central management platform module for the system of FIG. 1 and illustrating its connections to other entities;

FIG. 7 is a flow diagram of the information flows and processes performed by an edge gateway module for the system of FIG. 1; and

FIG. 8 is a flow diagram of the information flows and processes performed by a NCE module for the system of FIG. 1.

### DESCRIPTION OF PREFERRED EMBODIMENTS

The following description is of preferred embodiments by way of example only and without limitation to the combination of features necessary for carrying the invention into effect.

Reference in this specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments, but not other embodiments.

It should be understood that the elements shown in the FIGS, may be implemented in various forms of hardware, software or combinations thereof. These elements may be implemented in a combination of hardware and software on one or more appropriately programmed general-purpose devices, which may include a processor, memory and input/output interfaces.

The present description illustrates the principles of the present invention. It will thus be appreciated that those skilled in the art will be able to devise various arrangements that, although not explicitly described or shown herein, embody the principles of the invention and are included within its spirit and scope.

Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of systems and devices embodying the principles of the invention.

The functions of the various elements shown in the figures may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (“DSP”) hardware, read-only memory (“ROM”) for storing software, random access memory (“RAM”), and non-volatile storage.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. It is thus regarded that any means that can provide those functionalities are equivalent to those shown herein.

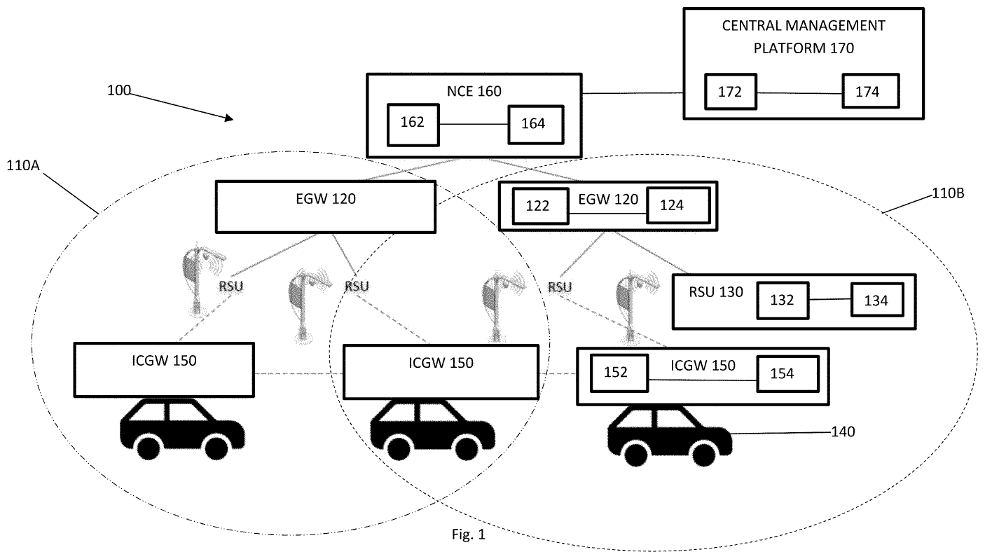

Referring to FIG. 1, provided is a schematic diagram illustrating one embodiment of a system 100 in accordance with the invention. The system 100 is preferably a communications network-based system 100 arranged as a plurality of defined local geographical areas 110A, B, each defined local geographical area 110A, B being managed by and/or in data communication with a respective edge gateway module (EGW) 120. Each EGW 120 communicates with a respective NCE 160 and each NCE communicates with a central management platform 170.

The defined local geographical areas 110A, B may overlap as shown in FIG. 1, although this is not necessarily the case and it is preferred that any overlaps between adjacent defined local geographical areas 110A, B are arranged to be as small as possible. Each EGW 120 preferably manages and is in communication with a plurality of roadside units (RSUs) 130. Each RSU 130 is preferably arranged alongside, adjacent or near to any one or more of a road, an intersection, a junction, a pedestrian crossing, a set of traffic lights, etc. such that each RSU has a reasonable line of sight to any vehicles located in or passing its near vicinity.

Vehicles 140 which are configured to operate within the network system 100 are each provisioned with a vehicle on-board data processing unit—hereinafter referred to as an in-car gateway module (ICGW) 150. The ICGW 150 may be a stand-alone unit configured to be installable into a vehicle 140 or it may comprise an existing data processing unit of the vehicle 140 having a memory 152 storing machine-readable instructions and a processor 154 for executing said instructions to cause the ICGW 150 to implement appropriate method steps of the invention. Each EGW 120 comprises at least a memory 122 for storing machine-readable instructions and a processor 124 for executing said instructions to cause the EGW 120 to implement appropriate method steps of the invention. In a similar manner, each RSU 130 comprises at least a memory 132 for storing machine-readable instructions and a processor 134 for executing said instructions to cause the RSU 130 to implement appropriate method steps of the invention.

Among other things, each ICGW 150 is preferably configured to provide V2X communication system access and information exchange with other ICGWs 150 and road infrastructure in the defined local geographical area 110A, B, to collect data from the vehicle on-board modules such as, for example, the speedometer and satellite positioning system, directly or indirectly exchange vehicle collected data with other local ICGWs 150, RSUs 130 and its respective EGW 120, use the vehicle collected data and data received from other local ICGWs 150, RSUs 130 and EGW 120 to determine threats and generate alarms, etc., and receive and issue V2X alarms and notifications as well as receive traffic status information and recommendations.

Each EGW 120 is preferably configured to at least coordinate multiple RSUs 130 within its respective defined local geographical area 110A, B, monitor traffic in real-time including monitoring traffic congestion and traffic incidents such as accidents, intelligently implement local traffic management, collect data from local infrastructure such as, for example, traffic lights, sensors, cameras, local ICGWs 150 and RSUs 130 and its respective NCE 160, collect policies from its respective NCE 160, and to use collected data to determine threats and generate alarms, etc. Each EGW 120 may be configured to determine from received and processed data specific data to be transmitted to a specific ICGW 150 in dependence on data received at said EGW 120 indicative of one or more parameters related to or associated with a vehicle of said specific ICGW 150. For example, a parameter such a street location may be utilized by the EGW 120 to determine which vehicles within its local geographical area 110A, B need to receive a specific alert, alarm, action or indication of threat.

A plurality of EGWs 120 are preferably managed by and/or in data communication with a respective NCE 160 and, in turn, a plurality of NCEs 160 are preferably managed by and/or in data communication with a central management platform module 170. The system 100 may comprise only a single central management platform module 170 to cover a large geographical region such as, for example a city, a county or a state. Each NCE 160 comprises at least a memory 162 for storing machine-readable instructions and a processor 164 for executing said instructions to cause the NCE 160 to implement appropriate method steps of the invention. Similarly, the central management platform module 170 comprises at least a memory 172 for storing machine-readable instructions and a processor 174 for executing said instructions to cause the central management platform module 170 to implement appropriate method steps of the invention.

Each NCE 160 is preferably configured to at least intelligently implement regional traffic management, define and provide new and updated traffic policies to the EGWs 120, and coordinate multiple EGWs 120.

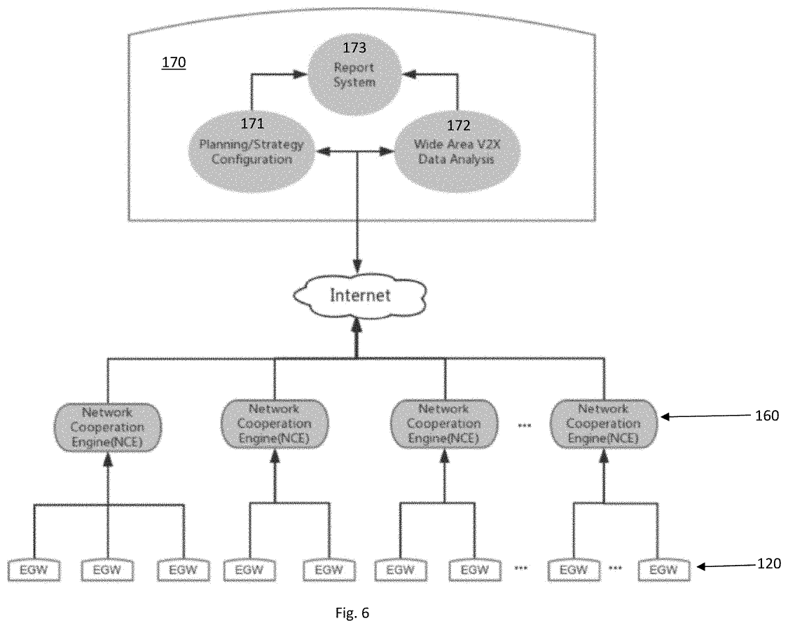

The central management platform module 170 is preferably configured to at least intelligently implement whole network traffic management, define traffic strategies for the NCEs 160 and manage and analyze network wide traffic data. The central management platform module 170 may comprise a cloud-based system and may connect to the NCEs 160 via an IP network such as the internet (FIG. 6) or a virtual private network (VPN).

It will be appreciated that the processing power of the central management platform module 170 will likely be very considerably greater than the processing power of any of the NCE 160, EGW 120, RSU 130 or ICGW 150. Despite this, it is envisaged that the central management platform module 170 will operate on high latency data and/or on long data processing periods to provide information related to, for example, road/traffic strategy and planning rather than time critical generation of alerts, determination of actions and/or determination of threats as will be performed at the local EGW 120 and RSU 130 level.

For enhancing safety alarm generation and/or threat detection accuracy for vehicles, multiple sources of information such as vehicles, pedestrian devices, roadside infrastructure, and communications network(s), etc. are required at low latency signal processing and delivery levels.

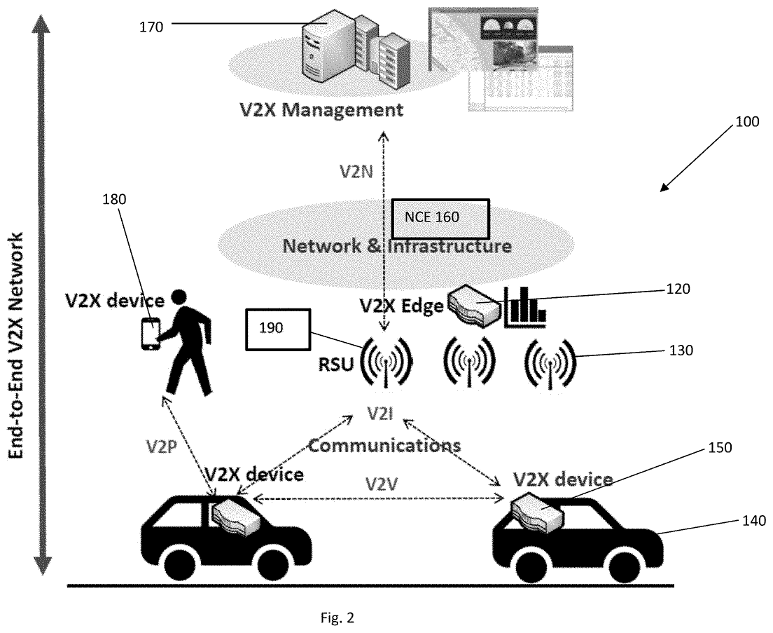

The network system 100 comprises a V2X system which preferably utilizes all local available sources of data including, but not limited to vehicle ICGWs 150, pedestrian devices 180 (FIG. 2), road infrastructure systems and devices 190 (FIG. 2) such as traffic lights, traffic cameras, emergency services databases, local authority databases and the like by way of informing EGWs, preferably in real-time, or at least at ultra-low latency, of events, situations or the like which may be relevant to enabling an EGW 120, a RSU 130 and/or a ICGW 150 to determine a threat to a vehicle 140 or another road user and/or to generate an alarm to a vehicle user or another road user.

As shown more clearly in FIG. 2, each ICGW 150 may utilize one or more standard communications interfaces to communicate with other network entities. For example, the ICGW 150 may utilize V2V to exchange data with other ICGWs 150 and/or utilize V2P to exchange data with pedestrian devices 180 and/or utilize V2I to exchange data with local infrastructure including the RSUs 130. The RSUs 130 and EGWs 120 preferably use V2N to exchange data with each other and higher-level network entities such as the NCEs 160 and the central management platform 170 as will be more fully explained hereinafter. Where appropriate, entities in the network system 100 may also utilize V2D and V2G. As such, the present invention provides, as illustrated by FIG. 2, an end-to-end V2X network system 100 having a multi-tier system architecture which utilizes information and algorithms performed at different tiers of the V2X network system to enable low latency generation of vehicle/road safety alarms and/or low latency determination of vehicle/road threats.

In the V2X network system 100, the EGWs 120 and/or RSUs 130 are configured to process local, real-time and/or low latency data to assist or provide alarms and/or determine threats to road users. The EGWs 120 and/or RSUs 130 will operate on data having a latency of 100 ms or less and preferably 50 ms or less. A low latency is regarded as comprising a data processing and delivery time in the range of 10 ms to 100 ms.

By confining processing of local real-time and/or low latency data to respective EGWs 120 and/or RSUs 130 on behalf of or in conjunction with ICGWs 150 and/or user devices 180, this enables the system 100 to provide or enable time-critical alarm generation and/or threat determination at the local level without the delays inherent of processing such data at higher level entities in the network system 100. A size of the defined geographical area 110A, B is selected such as to enable data from said one or more RSUs 130 and/or from a respective EGW 120 to be transmitted to said ICGWs 150 in real-time or at least at or less than a first, low level of latency.

In one embodiment, the V2X network system 100 of the invention provides a communications channel for at least providing additional data to ICGWs 150 to use in addition to on-vehicle data to generate alarms, to determine threats and/or to determine control actions for the vehicle to be implemented manually or autonomously. The V2X channel provided by the network system 100 is an efficient method of getting time-critical data to ICGWs 150 from local external sources that may affect the vehicle and vice versa.

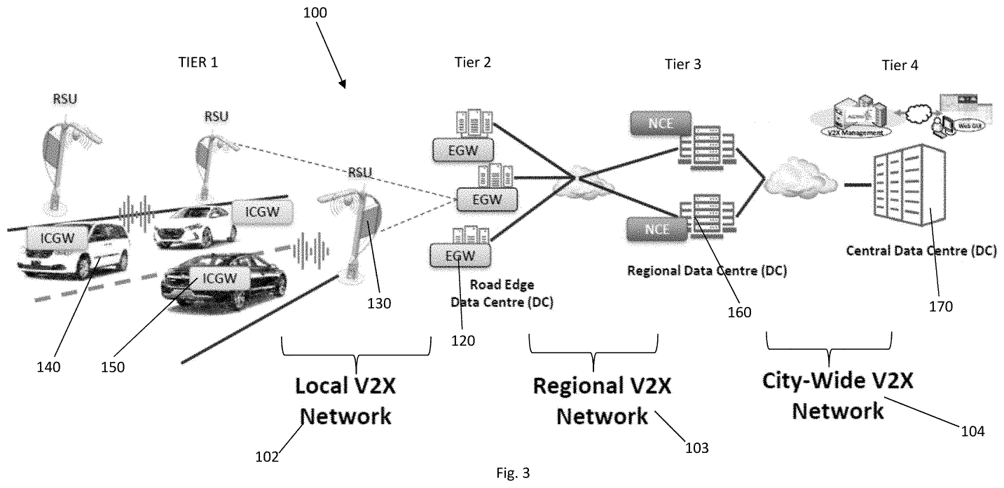

The multi-tiered arrangement of the network system 100 is more clearly seen from FIG. 3. A first tier can be considered as comprising any vehicles 140 with their associated ICGWs 150 within a geographical area of an EGW 120, any other road users such as pedestrians and their associated devices 180 (Fig.2), street level infrastructure such as smart traffic lights, camera systems, etc. and the RSUs 130. A second tier of the network system 100 comprises the EGWs 120. The first-tier entities are linked to the second-tier entities by what can be considered as a local V2X network 102 where data communications are exchanged using V2I, V2P and V2V. A third tier of the network system 100 can be considered as comprising the NCEs 160 and these are linked to the second-tier entities by what can be considered as a regional V2X network 103 operating over V2I. A fourth tier comprises the central management platform 170 which communicates using V2I over a city-wide, county-wide or state-wide V2X network 104.

The first and second tier entities preferably operate at signal latencies of 100ms or less and preferably at signal latencies of 50 ms or less. The third-tier entities preferably operate at signal latencies of 1000 ms or less whereas the fourth-tier entity operates at latencies of greater than 1000 ms and nearer to several seconds to minutes and even longer time periods. Consequently, the invention generally relates to a multi-tier V2X network architecture or software system to enable low latency road safety V2X alarm detection/threat determination at a local level whilst using information and algorithms performed at different higher-level tiers of the system operating at different, higher latency levels.

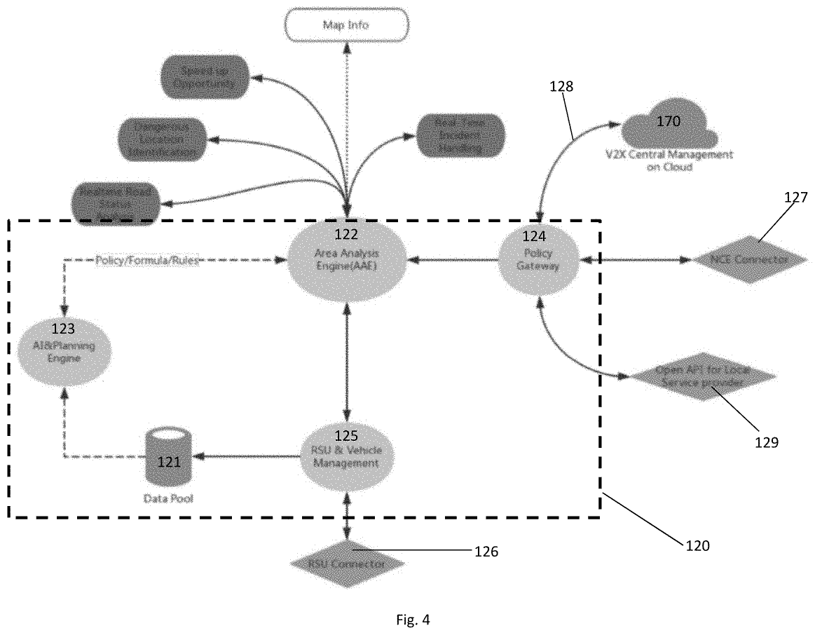

FIG. 4 illustrates the structure of an EGW 120 and its connections to other system entities and some of its information/data inputs. The EGW 120 comprises a database or data pool 121, an area analysis engine module (AAE) 122, an artificial intelligence (AI) planning engine module 123, a policy gateway module 124 and an RSU and vehicle management module 125. Data connectors may include a data connector 126 to one or more RSUs 130, a data connector 127 to an NCE 160 and optional data connectors 128, 129 to the central management platform 170 and an external service provider. Data inputs to the AAE 122 may include map data, real-time incident handling data, real-time road status analysis data, dangerous location identification data, and vehicle speed-up opportunity data.

The Al and planning engine module 123 is a software module within the EGW 120 configured to aggregate all data generated in the defined geographical area 110A, B of the EGW 120 and process said data using machine learning. The AAE 122 is a software module within the EGW 120 configured to process data generated in the defined geographical area 110A, B to determine any one or more of: real-time status of all roads in the defined geographical area; real-time status of all resources in the defined geographical area; real-time status of all RSUs 130 in the defined geographical area; real-time status of all ICGWs 150 in the defined geographical area; and real-time status of all incidents in the defined geographical area. The policy gateway module 124 is a software module within the EGW 120 configured to receive and configure rules and policies from the NCE 160 or from the central management platform 170, and to receive policy information from a local service using open standard Application Programming Interface (API). For example, local shops could send current retail and promotion information to broadcast to vehicles as low priority promotional information. The RSU and vehicle management module 125 is a software module within the EGW 120 configured to communicate data to the RSUs 130 and ICGWs 150 including real-time status information as described above and to configure at least the RSUs 130 in accordance with any policies received by the EGW 120.

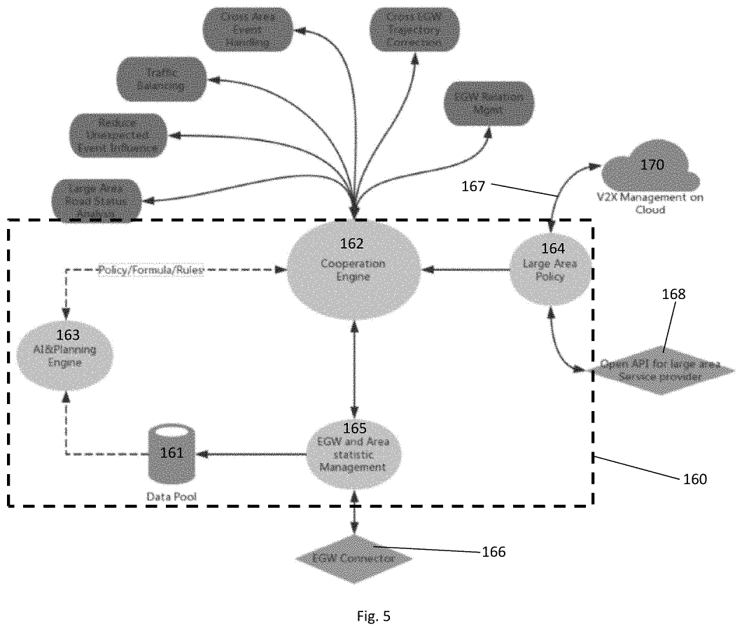

FIG. 5 illustrates the structure of an NCE 160 and its connections to other system entities and some of its information/data inputs. The NCE 160 comprises a database or data pool 161, a cooperation engine module 162, an artificial intelligence (AI) planning engine module 163, a large area policy gateway module 164 and an EGW and area statistics management module 165. Data connectors may include a data connector 166 to one or more EGWs 120, a data connector 167 to the central management platform 170 and optional data connector 168 to a large area external service provider. Data inputs may include EGW relationship data which describes the relationship such as relative positions of one EGW to another, cross EGW trajectory correction data, cross area event handling data, traffic balancing data, reduce unexpected event influence data, and large area road status analysis data.

Each EGW 120 managed by the NCE 160 is configured to communicate its local data for aggregation and extraction by the NCE 160 where the NCE 160 processes the aggregated and extracted data to provide one or more of: road management policy for the EGW defined geographical areas; regional traffic management for the EGW defined geographical areas; and coordinate and manage said plurality of EGWs. The cooperation engine module 162 is a software module within the NCE 160 configured to receive the data inputs and to process the EGW relationship data, the cross EGW trajectory correction data, the cross-area event handling data, traffic balancing data, and the reduce unexpected event influence data. It may also process the large area road status analysis data. The artificial intelligence (AI) planning engine module 163 is a software module within the NCE 160 configured to take all data uploaded from the EGWs 120 into the data pool 161 and to apply machine learning to such data. The machine learning may comprise supervised learning and may be done off-line. One output of the artificial intelligence (AI) planning engine module 163 includes policies, formulas and rules for the cooperation engine module 162 to apply. The artificial intelligence (AI) planning engine module 163 may also be configured to try and determine any relationships between any of the EGWs 120 to assist the cooperation engine module 162 to determine an area or region influenced or affected by, for example, a traffic incident. It will be understood that traffic congestion, for example, in one defined geographical area 110A, B will likely have greater influence or affect on an adjacent local area 110A, B than it would have on a more remote area. The large area policy gateway module 164 is a software module within the NCE 160 configured to receive configuration/rules/policies data from the V2X central management platform 170 and may also be configured to receive policy data from a large area service provider through an open standard API. The EGW and area statistics management module 165 is a software module within the NCE 160 configured to receive data from the cooperation engine module 162 and transmit such data to respective EGWs 120.

FIG. 6 illustrates the structure of the central management platform 170 and its connections to other system entities and some of its information/data inputs. The central management platform module 170 is in direct communication with a plurality of NCEs 160 and indirectly in communication with a plurality of EGWs 120. The central management platform module 170 comprises a planning/strategy configuration module 171, a wide area V2X data analysis module 172 and a report system module 173. The modules 171, 172 and 173 comprise software modules within the central management platform module 170. The central management platform module 170 aggregates and extracts data from the NCEs 160 and the EGWs 120 and processes the aggregated and extracted data to provide one or more of: road management policy for the defined geographical areas 110A, B of the EGWs 120; regional traffic management across NCEs 160 for the defined geographical areas 110A, B of the EGWs 120; directly coordinate said plurality of NCEs 160 and indirectly coordinate said plurality of EGWs 120; provide centralized management of the NCEs 160, EGWs 120 and RSUs 130; provide centralized management of the plurality of data sources located within each defined geographical area 110A, B; provide centralized vehicle to everything (V2X) network management; provide traffic analysis for the defined geographical areas 110A, B; and provide regional traffic analysis for the NCEs 160.

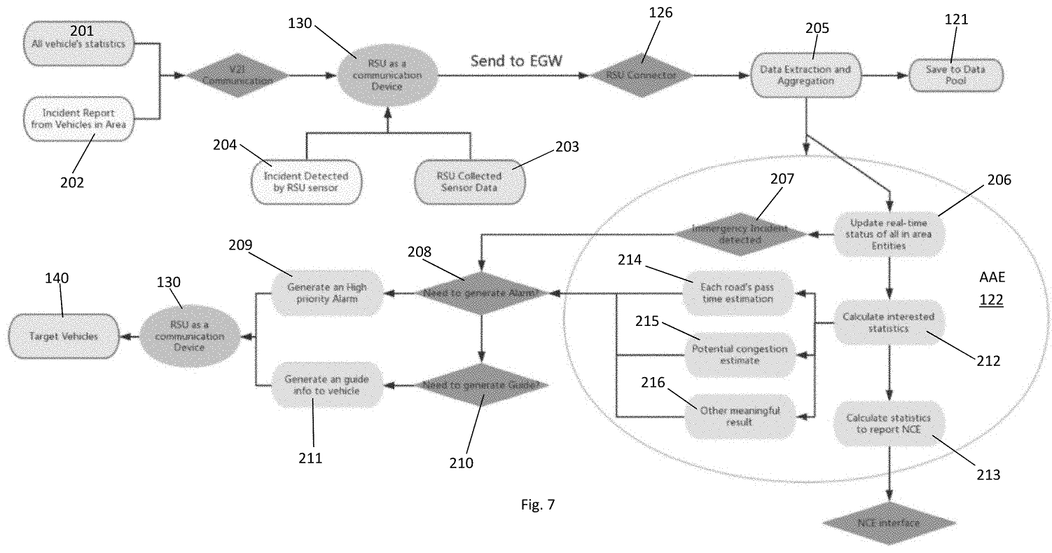

Referring to FIG. 7, provided is a flow diagram of the information flows and processes performed by an EGW 120. At 201, statistical data from the ICGWs 150 of all vehicles 140 located within the geographical area 110A, B of the EGW 120 together with, at 202, any incident report data from such ICGWs 150 are transmitted by V2I through a respective RSU 130 to the RSU data connector 126 of the EGW 120. At 203, data collected by a respective RSU 130 from associated data sources within the geographical area 110A, B are transmitted to the data connector 126 of the EGW 120 together with, at 204, any incident data detected by sensors of the RSU 130. At 205, data received at the data connector 126 is aggregated and stored in the data pool 121. Some or all of the aggregated data are passed to the AAE 122 which performs a number of functions including, at 206, updating the real-time statuses of all in-area entities. If, at 207, the updating step 206 identifies or detects an emergency incident, data describing the incident are forwarded to 208 to determine, for example, if there is a need to generate an alarm. In the event that it is determined at 208 that there is a need to generate an alarm, a further determination may be made at 209 as to whether or not it is necessary for the alarm to be considered a high priority alarm. In either case, alarm data are communicated via respective RSUs 130 to target vehicles 140. It will be understood that this is done in real-time or at least with very low latency of less than 100 ms. Furthermore, if at 208 it is determined that there is a need to generate an alarm, the method may include at 210 determining whether or not to generate guidance data or even action data for vehicles 140. This may include at 211 determining guidance data or action data for specific vehicles 140 in the geographical area 110A, B. Such guidance data or action data are communicated via respective RSUs 130 to target vehicles 140. Action data may comprise data which causes a target vehicle 140 to autonomously act without human involvement. For example, action data may cause a target vehicle to autonomously slow prior to reaching a pedestrian crossing if pedestrians have been sensed as being on or near the crossing and, more particularly, where pedestrians have been sensed as being on or near the crossing in vulnerable positions.

In addition to determining or detecting at 207 an emergency incident, the AAE 122 may be configured to calculate at 212 useful statistics such as traffic statistics and may include determining at 213 useful statistics to be transmitted to one or more NCEs 160. The statistical data generated at 212 may in turn be used at 214 to calculate a traffic pass time for each road in the geographical area 110A, B, at 215 to calculate potential congestion times, and at 216 calculate other meaningful statistics or parameters for the traffic situation in the geographical area 110A, B. The data generated at each or any of 214, 215 and 216 may also be used generate alarms and/or guidance/actions for targeted vehicles 140. Guidance data and/or action data may also be communicated target vehicles 140 via other vehicles using V2V.

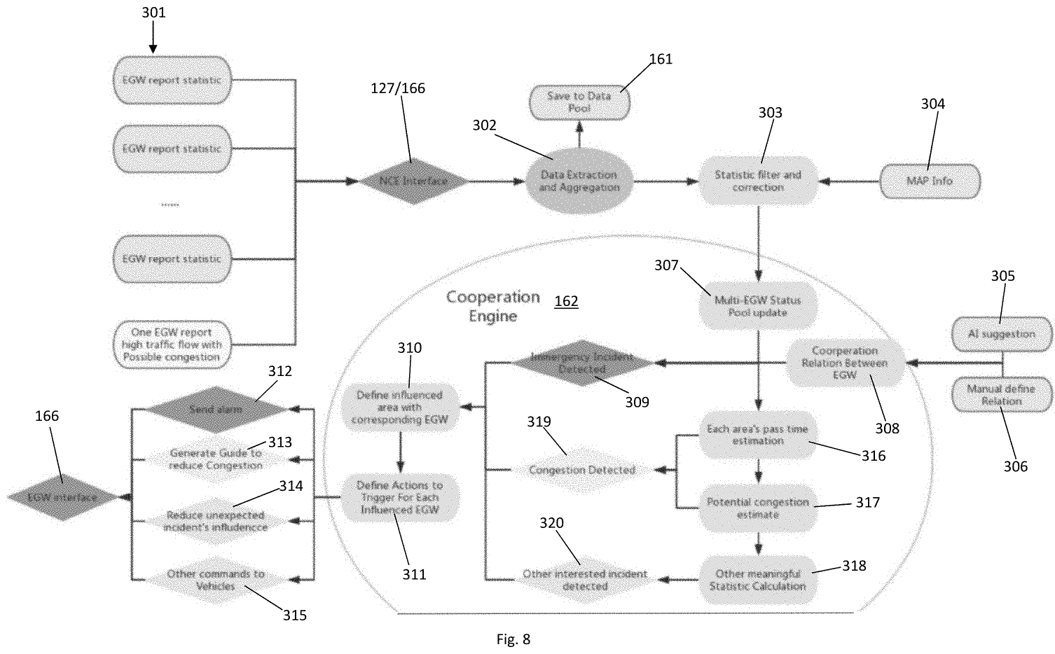

Referring to FIG. 8, provided is a flow diagram of the information flows and processes performed by an NCE 160. At 301, each EGW reports statistical data including, but not limited to, status report data, incident report data and congestion report data and transmits said data to its NCE data connector/interface 127 (NCE EGW data connector 166). At 302, said data is aggregated and stored in the NCE data pool 161. Some or all of said aggregated data are forwarded to the cooperation engine module 162, although, in an optional step at 303, said data may be filtered and corrected. Furthermore, map data may be input at 304. At 305 optional data inputs to the cooperation engine module 162 may include Al suggested inputs from any one of the EGW artificial intelligence (AI) planning engine module 123, the NCE artificial intelligence (AI) planning engine module 163, the central management platform planning/strategy configuration module 171, the wide area V2X data analysis module 172 or the report system module 173. At 306, optional data inputs to the cooperation engine module 162 may include manually defined relationship data such as, for example, the spatial relationships between EGWs 120 and their respective geographical areas 110A, B.

At 307, the cooperation engine module 162 receives multi-EGW status data from the EGW data pools 121. Based on this data and optionally on EGW relationship data received at 308, the cooperation engine module 162 may determine at 309 if any emergency incident has been detected and, if so, to define at 310 the area or areas and corresponding EGWs 120 affected by the incident and to define at 311 actions and/or alarms to trigger for each affected EGW 120. The actions and/or alarms may comprise, although are not limited to: 312 “send an alarm”; 313 “generate guide to reduce congestion”; 314 “reduce unexpected incident's influence”; and 315 “other commands to vehicles”. Once the actions and/or alarms are determined, these are issued to affected EGWs 120 via the EGW data connector/interface 166.

The cooperation engine module 162 may also use the multi-EGW status data and optionally the EGW relationship data to estimate any one or more of 316 each EGW area's pass time, 317 each EGW area's estimated potential congestion, and 318 other meaningful statistical data. The EGW area's pass time and EGW area's estimated potential congestion can be used at 319 to determine if congestion is detected and to use this data to define at 310 the area or areas and corresponding EGWs 120 affected by the incident and to define at 311 actions and/or alarms to trigger for each affected EGW 120. The other meaningful statistical data can be used at 320 to determine any other detected incident and to also use this data to define at 310 the area or areas and corresponding EGWs 120 affected by the incident and to define at 311 actions and/or alarms to trigger for each affected EGW 120.

Generally speaking, the invention provides a system for improving road safety of a vehicle. The system comprises a central management platform for managing a plurality of network cooperation engine (NCE) modules. Each NCE module manages a plurality of edge gateway devices (EGWs) which are each located in a respective defined geographical area of limited size. Each EGW communicates with multiple roadside units (RSUs) in its area and exchanges real-time and low latency information with said RSUs and with any vehicle on-board data processing units (ICGWs) in vehicles presently within its area. Each ICGW is adapted to be installable in a vehicle. The ICGW is configured to receive real-time data from one or more on-board vehicle modules. The ICGW is also configured to receive data from its EGW and the RSUs which are themselves configured to receive data from a plurality of sources located within said defined geographical area and to transmit said received data and/or data derived from said received data to said ICGW. The ICGW is configured to process data to autonomously determine any one or more of: a threat to the vehicle; an alert to be issued; and a control action to be implemented for the vehicle. A size of the defined geographical area may be selected such as to enable data from said EGW and/or RSUs to be transmitted to said ICGW in real-time or at least at or less than a first, low level of latency.

The apparatus described above may be implemented at least in part in software. Those skilled in the art will appreciate that the apparatus described above may be implemented at least in part using general purpose computer equipment or using bespoke equipment.

Here, aspects of the methods and apparatuses described herein can be executed on any apparatus comprising the communication system. Program aspects of the technology can be thought of as “products” or “articles of manufacture” typically in the form of executable code and/or associated data that is carried on or embodied in a type of machine readable medium. “Storage” type media include any or all of the memory of the mobile stations, computers, processors or the like, or associated modules thereof, such as various semiconductor memories, tape drives, disk drives, and the like, which may provide storage at any time for the software programming. All or portions of the software may at times be communicated through the Internet or various other telecommunications networks. Such communications, for example, may enable loading of the software from one computer or processor into another computer or processor. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible non-transitory “storage” media, terms such as computer or machine “readable medium” refer to any medium that participates in providing instructions to a processor for execution.

While the invention has been illustrated and described in detail in the drawings and foregoing description, the same is to be considered as illustrative and not restrictive in character, it being understood that only exemplary embodiments have been shown and described and do not limit the scope of the invention in any manner. It can be appreciated that any of the features described herein may be used with any embodiment. The illustrative embodiments are not exclusive of each other or of other embodiments not recited herein. Accordingly, the invention also provides embodiments that comprise combinations of one or more of the illustrative embodiments described above. Modifications and variations of the invention as herein set forth can be made without departing from the spirit and scope thereof, and, therefore, only such limitations should be imposed as are indicated by the appended claims.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art.

1. A system for improving road safety and/or management of a vehicle comprising:
a vehicle on-board data processing unit for a vehicle configured to receive real-time data from one or more on-board vehicle modules;
one or more roadside units placed within a defined geographical area and configured to receive data from a plurality of sources located within said defined geographical area and to transmit said received data and/or data derived from said received data to said vehicle on-board data processing unit;
wherein said vehicle on-board data processing unit is configured to process said real-time data from said one or more on-board vehicle modules and said data from said one or more roadside units to autonomously determine any one or more of: a threat to the vehicle; an alert to be issued; and a control action to be implemented for the vehicle, and
wherein a size of the defined geographical area is selected such as to enable data from said one or more roadside units to be transmitted to said vehicle on-board data processing unit in real-time or at a first level of latency.

2. The system of claim 1, wherein the defined geographical area is limited in size such as to enable data from said one or more roadside units to be transmitted to said vehicle on-board data processing unit with a low latency less than or equal to 100 ms.

3. The system of claim 1, wherein the vehicle on-board data processing unit is configured to communicate with the one or more roadside units using a standard communications interface.

4. The system of claim 3, wherein the standard communications interface comprises a vehicle to infrastructure (V2I) interface.

5. The system of claim 1, wherein, in addition to receiving data from one or more on-board vehicle modules and data from said one or more roadside units, the vehicle on-board data processing unit is configured to receive data from one or more of: one or more pedestrian communication devices; and one or more other vehicle on-board data processing units, and to use said received data to determine any one or more of: a threat to the vehicle; an alert to be issued; and a control action to be implemented for the vehicle.

6. The system of claim 1, wherein the vehicle on-board data processing unit is configured to send data directly or indirectly to one or more other vehicle on-board data processing units.

7. The system of claim 1, further comprising an edge gateway module in communication with said one or more roadside units, said edge gateway module being configured to receive and process data from said one or more roadside units and to determine from said processed data which data are to be transmitted to said vehicle on-board data processing unit.

8. The system of claim 7, wherein the edge gateway module is configured to determine from said processed data specific data to be transmitted to said vehicle on-board data processing unit in dependence on data received at said edge gateway module indicative of one or more parameters related to or associated with the vehicle of said on-board data processing unit.

9. The system of claim 7, wherein the edge gateway module is configured to communicate with a plurality of vehicle on-board data processing units, each vehicle on-board data processing unit being associated with a respective vehicle, and to communicate with a plurality of roadside units within said defined geographical area, said edge gateway module being configured to receive data from the plurality of sources located within said defined geographical area, to receive data from one or more vehicle on-board data processing units of vehicles located within said defined geographical area, and to receive data defining road management policy for the defined geographical area and to process said received data to determine one or more of: a threat to one or more of the vehicles; an alert to be issued to one or more of the vehicles; and a control action to be implemented for one or more of the vehicles.

10. The system of claim 7 further comprising a network cooperation engine module in communication with a plurality of edge gateway modules, each edge gateway module configured to manage local data of a respective defined geographical area and to communicate its local data for aggregation and extraction by the network cooperation engine module, the network cooperation engine module being configured to process the aggregated and extracted data to provide one or more of: road management policy for the defined geographical areas; regional traffic management for the defined geographical areas of said plurality of edge gateway modules; coordinate said plurality of edge gateway modules; and manage said plurality of edge gateway modules.

11. The system of claim 10, wherein the network cooperation engine module is configured to operate at a second level of latency where said second level of latency is higher than said first level of latency.

12. The system of claim 11, wherein the second level of latency is less than or equal to 1000 ms.

13. The system of claim 7, wherein the edge gateway module comprises an Al and planning engine module for aggregating all data generated in the defined geographical area of the edge gateway module and processing said data using machine learning.

14. The system of claim 7, wherein the edge gateway module comprises an area analysis engine module for processing data generated in the defined geographical area of the edge gateway module to determine any one or more of: real-time status of all roads in the defined geographical area; real-time status of all resources in the defined geographical area; real-time status of all roadside units in the defined geographical area; real-time status of all vehicle on-board data processing units in the defined geographical area; and real-time status of all incidents in the defined geographical area.

15. The system of claim 7, further comprising a central management platform module in communication with a plurality of edge gateway modules, each edge gateway module configured to manage local data of a respective defined geographical area and to communicate its local data for aggregation and extraction by the central management platform module, the central management platform module being configured to process the aggregated and extracted data to provide one or more of: road management policy for the defined geographical areas; regional traffic management for the defined geographical areas of said plurality of edge gateway modules; coordinate said plurality of edge gateway modules; manage said plurality of edge gateway modules; centralized management of the edge gateway modules; centralized management of the roadside units; centralized management of the plurality of sources located within each defined geographical area; centralized vehicle to everything (V2X) network management; local traffic analysis for the defined geographical areas of said plurality of edge gateway modules; regional traffic analysis for a plurality of network cooperation engine module which facilitate communication between the central management platform module and the edge gateway modules.

16. The system of claim 15, wherein the central management platform module is configured to operate at a third level of latency where said third level of latency is higher than said second level of latency.

17. The system of claim 16, wherein the third level of latency is greater than 1000 ms.

18. The system of claim 16, wherein the system comprises an end to end V2X network.

19. A method of improving road safety of a vehicle comprising:
receiving real-time data from one or more on-board vehicle modules;
receiving low latency data from one or more roadside units placed within a defined geographical area, said one or more roadside units receiving data from a plurality of sources located within said defined geographical area; and
processing said real-time data from said one or more on-board vehicle modules and said data from said one or more roadside units to autonomously determine any one or more of: a threat to the vehicle; an alert to be issued; and a control action to be implemented for the vehicle,
wherein said real-time data and said low latency data are received and processed at a location within the defined geographical area and any determination made based on said data is delivered to a location within the defined geographical area.

20. A vehicle on-board data processing unit for improving road safety of a vehicle comprising:
a non-transitory, computer-readable medium storing machine-executable instructions; and
a processor connected to the non-transitory computer-readable medium configured to execute the machine-executable instructions to arrange said vehicle on-board data processing unit to:
receive real-time data from one or more on-board vehicle modules;
receive low latency data from one or more roadside units placed within a defined geographical area, said one or more roadside units receiving data from a plurality of sources located within said defined geographical area; and
process said real-time data from said one or more on-board vehicle modules and said low latency data from said one or more roadside units to autonomously determine any one or more of: a threat to the vehicle; an alert to be issued; and a control action to be implemented for the vehicle.

21. An edge gateway module for a system for improving road safety and/or management comprising:
a non-transitory, computer-readable medium storing machine-executable instructions; and
a processor connected to the non-transitory computer-readable medium configured to execute the machine-executable instructions to cause said edge gateway module to:
receive data from one or more roadside units placed within a defined geographical area managed by and/or in data communication with said edge gateway module;
transmit data received from said one or more roadside units and/or data derived from said received data to one or more vehicle on-board data processing units of vehicles located within said defined geographical area;
wherein a size of the defined geographical area is selected such as to enable data received from said one or more roadside units to be transmitted by said edge gateway module to said one or more vehicle on-board data processing units in real-time or at a first level of latency.
